(19) United States
(12) Patent Application Publication
(10) Pub. No.: US 2020/0042750 A1
(43) Pub. Date: Feb. 6, 2020

(54) SECURE ACCESS FOR SYSTEM POWER MANAGEMENT INTERFACE (SPMI) DURING BOOT

(71) Applicant: QUALCOMM Incorporated, San Diego, CA (US)

(72) Inventors: Christopher Kong Yee CHUN, Austin, TX (US); Dilin VALIPARAMBIL DIVAKAR, Bangalore (IN); Uma Mahesh REVURI, San Diego, CA (US); Graham ROFF, San Diego, CA (US)

(21) Appl. No.: 16/052,892

(22) Filed: Aug. 2, 2018

(51) Int. Cl. G06F 21/85; G06F 21/57

(52) U.S. Cl. CPC G06F 21/85; G06F 21/575

(57) ABSTRACT

A storage device is pre-loaded with an access block including a list of device addresses with which the device is either permitted or not permitted to communicate over a shared bus prior to a bootloader being initiated on the device. A communication circuit is coupled to the storage device, and the circuit is adapted to: (a) obtain a first command to be transmitted over the shared bus to a first device address; (b) determine whether the first device address is in the list of device addresses in the access block; and (c) allow or prevent transmission of the first command over the shared bus based on whether the firt device address is in the list of device addresses. The list of device addresses is bypassed or ignored after the bootloader procedure is completed.

### TECHNICAL FIELD

The present disclosure relates generally to serial communication over a shared serial bus and, more particularly, to protecting devices from unauthorized access prior to security procedures being implemented by a bootloader.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a multi-drop serial bus or a parallel bus. General-purpose serial interfaces known in the industry include the Inter-Integrated Circuit (I2C or I²C) serial bus and its derivatives and alternatives. The Mobile Industry Processor Interface (MIPI) Alliance defines standards for I3C, the Radio Frequency Front-End (RFFE) interface and other interfaces.

In one example, the I3C serial bus may be used to connect sensors and other peripherals to a processor. In some implementations, multiple bus masters are coupled to the serial bus such that two or more devices can serve as bus master for different types of messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links In another example, system power management interface (SPMI) defined by the MIPI Alliance provides a hardware interface that may be implemented between baseband or application processors and peripheral components. In some implementations, the SPMI is deployed to support power management operations within a device.

Many electronic devices include multiple components that may communicate with each other over a bus. One such example, is a system that includes a plurality of devices that use a System Power Management Interface (SPMI) to communicate over a two line serial bus. In such systems one device may operate as a “master” while other devices may operate as “slaves”, where the master is the sender of communications over the bus. In some systems, the “master” device may dynamically change such that any device coupled to the bus may become a “master” device. During boot-up, security of the devices on the bus is often setup during a boot loader security procedure (e.g., a secondary boot loader). However, prior to such security being established, the devices on the bus may be susceptible to rogue software making unwanted changes to the system (i.e., accessing and changing the devices on the bus).

Therefore, there is a need for a process to secure devices coupled to the bus during the time when the secondary boot loader has not yet setup.

### SUMMARY

A first aspect provides a device including a storage device and a communication circuit. The storage device may include an access block with a list of device addresses with which the device is either permitted or not permitted to communicate over a shared bus prior to a bootloader procedure being initiated on the device. The communication circuit may be adapted to: (a) obtain a first command to be transmitted over the shared bus to a first device address; (b) determine whether the first device address is in the list of device addresses in the access block; (c) allow or prevent transmission of the first command over the shared bus based on whether the first device address is in the list of device addresses; and/or (d) bypass or ignore the determination of whether the first device address is in the list of device addresses after the bootloader procedure is completed. The bootloader procedure may include a security procedure executed after a basic input/output system (BIOS) is loaded for the device.

In one example, allowing or preventing transmission of the first command includes: transmit the first command if: (a) the first device address is in the list of device addresses with which the device is permitted to communicate; or (b) the first device address is not in the list of device addresses with which the device is not permitted to communicate; and terminating transmission of the first command if: (c) the first device address is in the list of device addresses with which the device is not permitted to communicate; or (d) the first device address is not in the list of device addresses with which the device is permitted to communicate.

In some implementations, the first command may be one of a read or write command from/to a register in another device associated with the first device address.

In some examples, each device address in the list of device addresses may define: (a) one or more devices, (b) one or more register addresses, and/or (c) one or more ranges of addresses.

According to another example, the communication circuit may be further adapted to: (A) receive a second command over the shared bus from another device having a second device address; (B) determine whether the second device address is in the list of device addresses in the access block; an/or (C) terminate processing of the second command if: (a) the second device address is in the list of device addresses with which the device is not permitted to communicate; or (b) the second address is not in the list of device addresses with which the device is permitted to communicate.

Additionally, the communication circuit may be further adapted to: transmit the second command if: (a) the second device address is in the list of device addresses with which the device is permitted to communicate; or (b) the second device address is not in the list of device addresses with which the device is not permitted to communicate.

The second command may be one of a read or write command from/to a register in the device associated with the second device address.

The communication circuit may be a System Power Management Interface (SPMI).

A second aspect provides a method, comprising: (A) storing an access block with a list of device addresses with which a device is either permitted or not permitted to communicate over a shared bus prior to a bootloader procedure being initiated on the device; (B) obtaining, at a communication circuit, a first command to be transmitted over the shared bus to a first device address; (C) determining whether the first device address is in the list of device addresses in the access block; (D) allowing or preventing transmission of the first command over the shared bus based on whether the first device address is in the list of device addresses, and/or (E) bypassing or ignoring the determination of whether the first device address is in the list of device addresses after the bootloader procedure is completed. The bootloader procedure may be a security procedure executed after a basic input/output system (BIOS) is loaded for the device.

According to one example, allowing or preventing transmission of the first command may include transmiting the first command if: (a) the first device address is in the list of device addresses with which the device is permitted to communicate; or (b) the first device address is not in the list of device addresses with which the device is not permitted to communicate; and terminating transmission of the first command if: (c) the first device address is in the list of device addresses with which the device is not permitted to communicate; or (d) the first device address is not in the list of device addresses with which the device is permitted to communicate. The first command may be one of a read or write command from/to a register in another device associated with the first device address. In some example, each device address in the list of device addresses may define: (a) one or more devices, (b) one or more register addresses, and/or (c) one or more ranges of addresses.

Additinally, the method may further comprise: (a) receiving a second command over the shared bus from another device having a second device address; and/or (b) determining whether the second device address is in the list of device addresses in the access block. The processing of the second command may be terminated if: (a) the second device address is in the list of device addresses with which the device is not permitted to communicate; or (b) the second address is not in the list of device addresses with which the device is permitted to communicate. Moreover, the method may further comprise: processing the second command if: (a) the second device address is in the list of device addresses with which the device is permitted to communicate; or (b) the second device address is not in the list of device addresses with which the device is not permitted to communicate. In one example, the communication circuit may be a System Power Management Interface (SPMI).

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates a device that employs an SPMI bus to couple various devices in accordance with certain aspects disclosed herein.

FIG. 5 illustrates a generic power-up/reset sequence for a device and/or system.

FIG. 6 is a block diagram illustrating a system in which at least one device includes an access control block that restricts access to/from the device prior to security procedures being implemented by a bootloader.

FIG. 7 illustrates a system with various examples of devices having integrated security access blocks that restrict communications to/from the devices prior to other bootloader security procedures being implemented.

FIG. 8 illustrates various examples of how a security access block may be implanted.

FIG. 9 illustrates examples of security access control blocks.

FIG. 10 is a diagram illustrating an example of a device having integrated access control blocks that operate prior to a bootloader security procedures for the device being initiated.

FIG. 11 is a flowchart of a method that may be performed by a device, having integrated access control blocks, prior to a bootloader security procedure for the device being initiated.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. For example, the serial bus may be operated in accordance with an I2C, I3C, SPMI, and/or RFFE protocol, or other protocol that may be configured for half-duplex operation. Increased utilization of serial buses, and/or the imposition of more stringent timing constraints in support of applications, peripherals and sensors can result in demand for reduced transmission latencies. Transmission latency may include the time required to terminate a transaction in process on the serial bus, bus turnaround (between transmit mode and receive mode), bus arbitration and/or command transmissions specified by protocol.

In order to mitigate or prevent the device coupled to a shared bus of a host system from being accessed/changed by rogue software prior to security being established on the host system, a device may be pre-configured (or pre-loaded) with access control blocks that define addresses (e.g., device addresses and/or register addresses or address ranges) with which the device is permitted or not permitted to communicate. Such addresses may identify other devices on the bus, register addresses, and/or groups of devices/registers on the bus. Consequently, when a command is generated or received at a device, the address in the command is checked to see if the address is identified in the access control block (either as permitted or not permitted). The command is blocked if it is a not permitted address or if it is absent from the permitted addresses. This process of checking the access control block and blocking commands may be performed only during a defined period of time (e.g., while the bootloader security procedure has not completed). In various implementations, the blocking of commands using the access control block may be performed at a transmitter circuit, a receiver circuit, and/or a processing circuit which generates a command to be transmitted or which was received over the bus. The checking of the access control block addresses may be disabled or bypassed after the bootloader security procedure is done.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

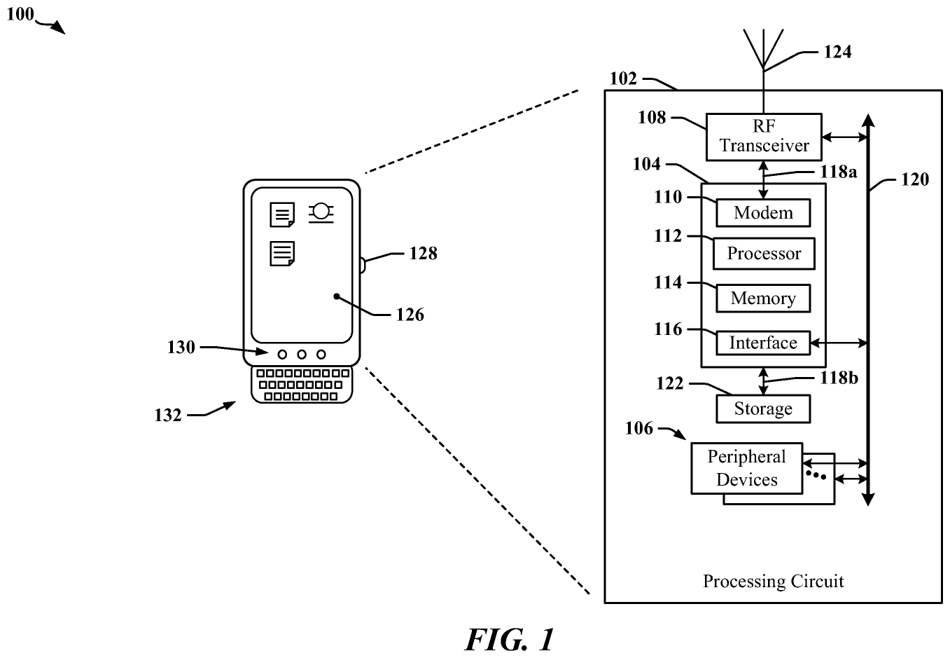

FIG. 1 illustrates an example of an apparatus 100 that may employ a data communication bus. The apparatus 100 may include a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions/code and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

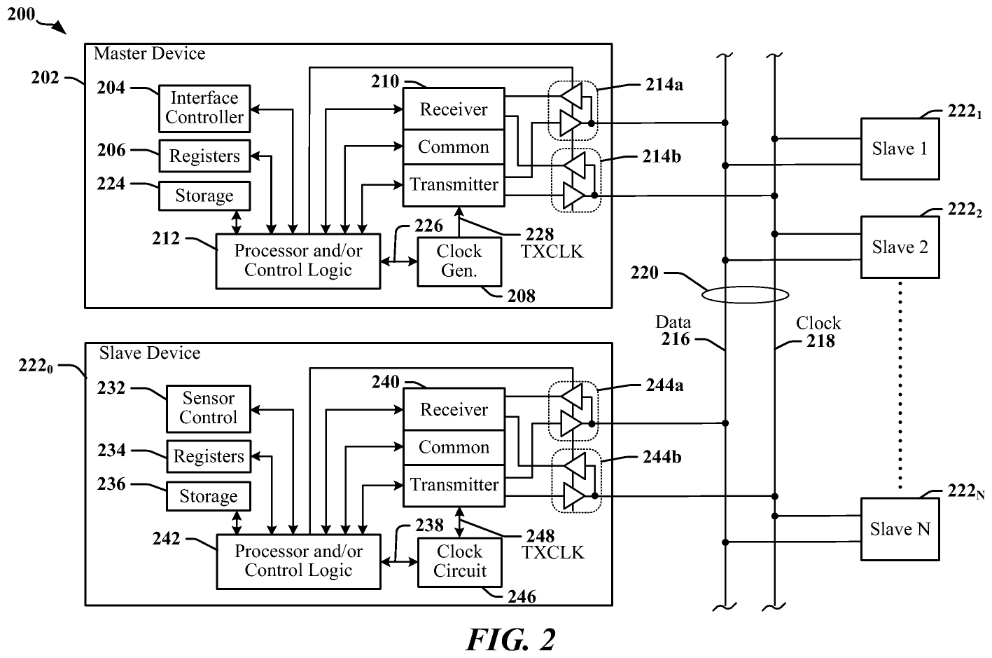

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an applications processor, SoC or ASIC. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a bus master 202. Certain types of bus can support multiple bus masters 202.

In one example, a master device 202 may include an interface controller 204 that may manage access to the serial bus, configure dynamic addresses for slave devices 222₀-222_{N} and/or generate a clock signal 228 to be transmitted on a clock line 218 of the serial bus 220. The master device 202 may include configuration registers 206 or other storage 224, and other control logic 212 configured to handle protocols and/or higher level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common/shared circuits, where the common/shared circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with RFFE, I2C, I3C, SPMI, or other protocols. At least one device 202, 222₀-222_{N} may be configured to operate as a master device and a slave device on the serial bus 220. Two or more devices 202, 222₀-222_{N} may be configured to operate as a master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

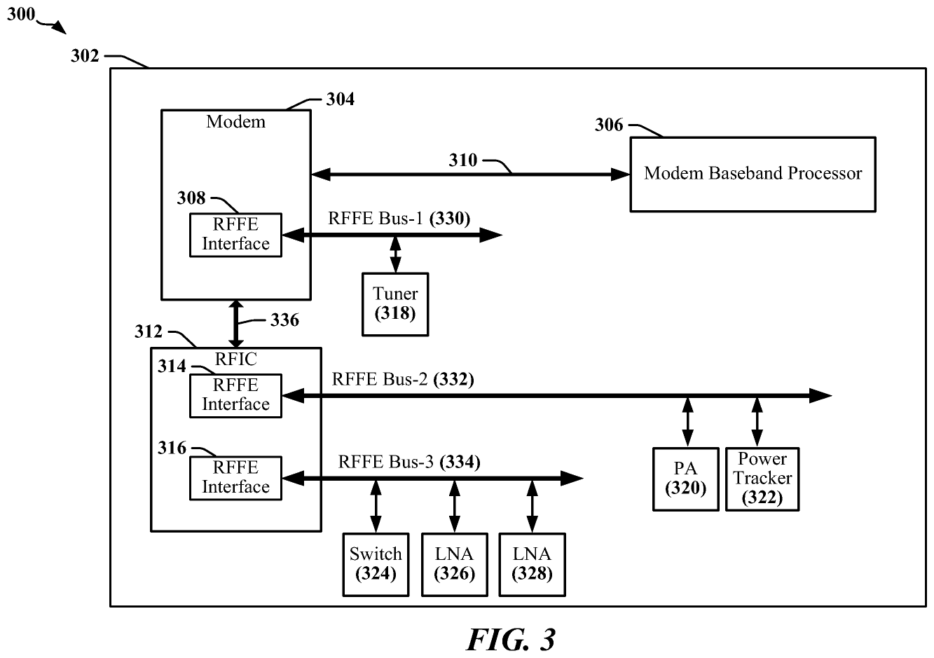

FIG. 3 is a block diagram 300 illustrating a second example of a configuration of communication links in a chipset or device 302 that employs multiple RFFE buses 330, 332, 334 to couple various RF front-end devices 318, 320, 322, 324, 326 328. In this example, a modem 304 includes an RFFE interface 308 that couples the modem 304 to a first RFFE bus 330. The modem 304 may communicate with a baseband processor 306 and a Radio-Frequency IC (RFIC 312) through one or more communication links 310, 336. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the device 302 may be implemented with one or more baseband processors 306, modems 304, RFICs 312, multiple communications links 310, 336, multiple RFFE buses 330, 332, 334 and/or other types of buses. The device 302 may include other processors, circuits, modules and may be configured for various operations and/or different functionalities. In the example illustrated in FIG. 3, the Modem is coupled to an RF tuner 318 through its RFFE interface 308 and the first RFFE bus 330. The RFIC 312 may include one or more RFFE interfaces 314, 316, controllers, state machines and/or processors that configure and control certain aspects of the RF front-end. The RFIC 312 may communicate with a PA 320 and a power tracking module 322 through a first of its RFFE interfaces 314 and the second RFFE bus 332. The RFIC 312 may communicate with a switch 324 and one or more LNAs 326, 328.

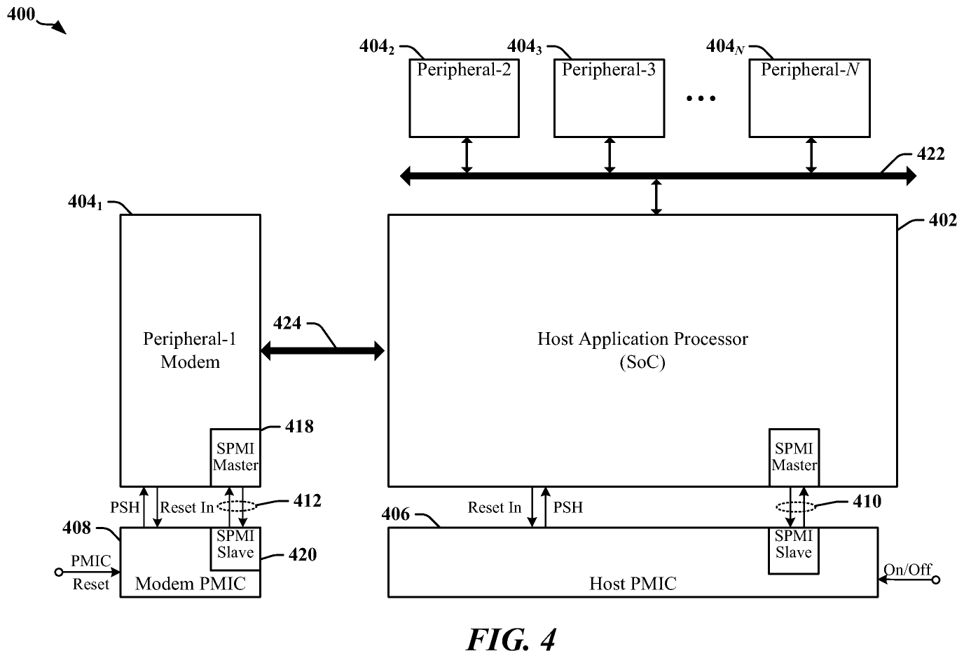

The MIPI Alliance system power management interface (SPMI) specifies a hardware interface that may be implemented between baseband or application processors and peripheral components to support a variety of data communication functions including data communication related to power management operations. FIG. 4 illustrates an example of a system 400 which includes data communication links 410, 412, where each of the data communication links 410, 412 is configured as a two-wire serial bus operated in accordance with SPMI protocols. In one example, a first data communication link 410 may be used to connect an integrated power controller of an application processor 402 with a voltage regulation system in a first power management integrated circuit (PMIC 406), and a second data communication link 412 may be used to connect an integrated power controller of a modem 404₁ with a voltage regulation system in a second PMIC 408. The data communication links 410, 412 can be used to accurately monitor and control processor performance levels required for a given workload or application and dynamically control the various supply voltages in real time based on the performance levels. The data communication links 410, 412 can be used to carry other types of data between the application processor 402 and the first PMIC 406 and/or between the modem 404₁ and the second PMIC 408. SPMI data communication links may be implemented as multi-drop serial links to connect a variety of different devices and to carry other types of data. Some SPMI data communication links may be optimized for real-time power management functions. Some SPMI data communication links may be may be used as a shared bus that provides high-speed, low-latency connection for devices, where data transmissions may be managed, according to priorities assigned to different traffic classes.

In the system 400 illustrated in FIG. 4, the application processor 402 that may serve as a host device on various data communication links 410, 422, multiple peripherals 404₁-404_{N}, and one or more PMICs 406. The application processor 402 and the modem 404₁ may be coupled to respective PMICs 406, 408 using power management interfaces implemented using SPMI masters 414, 418. The SPMI masters 414, 418 communicate with corresponding SPMI slaves 416, 420 provided in the PMICs 406, 408 to facilitate real-time control of the PMICs 406, 408. The application processor 402 may be coupled to each of the peripherals 404₁-404_{N} using different types of data communication links 410, 412. For example, the data communication links 410, 412 may be operated in accordance with protocols such as the RFFE, SPMI, I3C protocols.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

Multi-drop interfaces such as RFFE, SPMI, I3C, etc. can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. In some examples herein, the RFFE and SPMI protocols may be employed to illustrate certain aspects disclosed herein. However, the concepts disclosed herein are applicable to other serial bus protocols and standards. Some similarities exist between RFFE and SPMI datagram structures.

Securing Devices Pre-Boot Loader

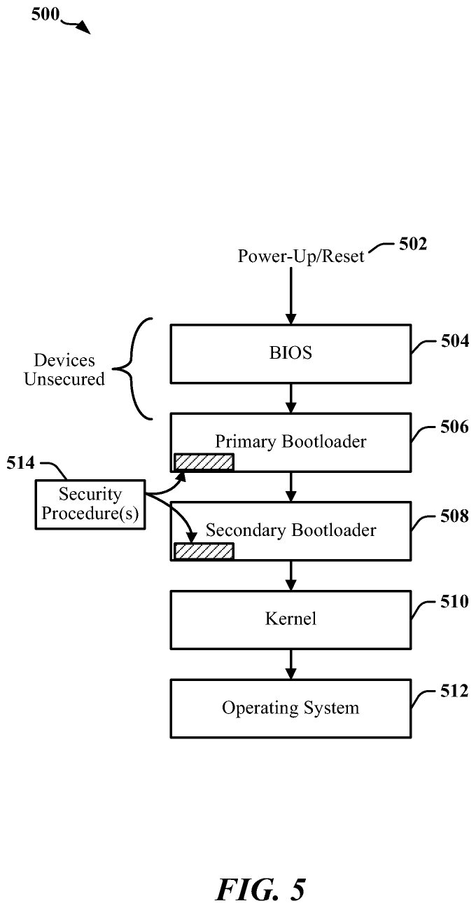

FIG. 5 illustrates a generic power-up/reset sequence for a device and/or system. For instance, the devices and/or systems illustrated in FIGS. 1-4 may use some of the sequence steps illustrated in FIG. 5. Upon a power-up, restart, or reset 502 of a device or system, may load a BIOS (basic input/output system) 504 which identifies hardware devices in a system and manages data flow between the identified devices. It is during this stage that devices coupled to a bus may be identified and/or enumerated with a device identifier. The BIOS 504 also seeks bootloaders stored in storage devices within the system. In some implementations, a multi-stage bootloader may be used, such as a primary bootloader 506 and a secondary bootloader 508. For instance, the primary bootloader 506 may simply serve to load the secondary bootloader 508. The primary bootloader 506 and/or secondary bootloader 508 may execute low-level code that includes instructions that tell one or more of the devices in the system how to start up and find a system kernel. Additionally, the primary bootloader 506 and/or secondary bootloader 508 may include instructions that establish certain security measures or procedures 514 that may restrict operation of some or all devices in the system (e.g., restrict which devices are able to communicate over a bus, restrict which devices may perform certain operations over the bus, etc.). Once the bootloaders are executed, the secondary bootloader 508 may obtain a kernel image and the kernel 510 may be decompressed and/or executed/initialized. When the kernel 510 completes its operations, an operating system 512 (e.g., a high-level system) may be initialized or executed.

However, prior to security procedures 514 being established (e.g., in the bootloader stages 506 and/or 508), devices in the system are unsecured and may be susceptible to unauthorized access. That is, prior to security procedures 514, devices within the system may be accessed (e.g., read from or written to) by a rogue device coupled to the same bus.

To secure devices prior to security procedures implemented during a bootloader stage, access control blocks may be used at each device, where the access control blocks define device addresses, device address ranges, and/or register address(es) with which a device is allowed to communicate.

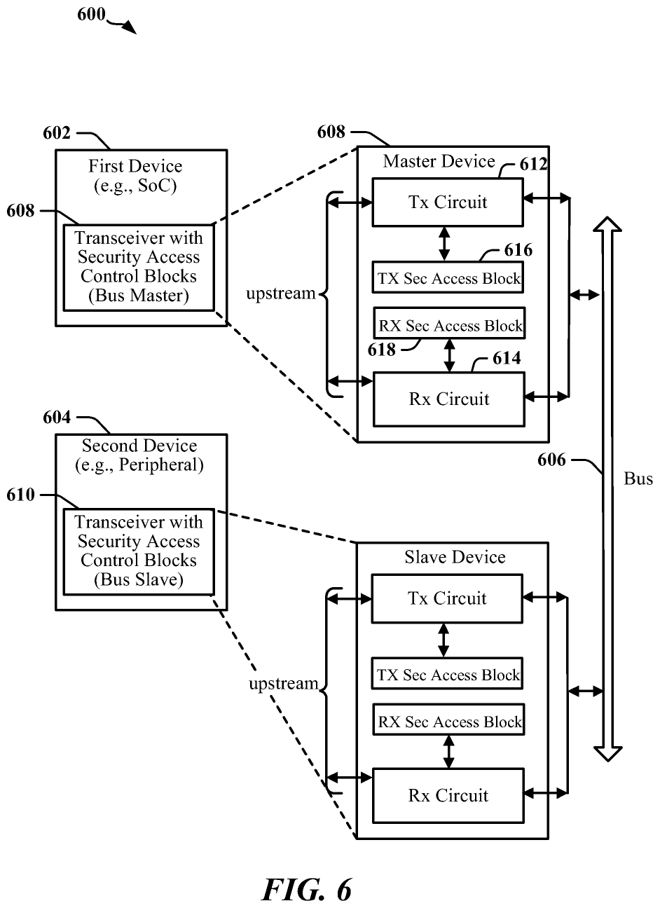

FIG. 6 is a block diagram illustrating a system 600 in which at least one device includes an access control block that restricts access to/from the device prior to security procedures being implemented by a bootloader. In this example, the system 600 may include at least a first device (e.g., a system-on-chip (SoC) device) and a second device 604 (e.g., second device), both coupled to a shared common bus 606. The SoC device 602 may operate as a master over the bus 606 to manage or control communications over the bus 606. The SoC device 602 may also include a transceiver 608 (e.g., transmitter and receiver) with integrated security access checking. In this example, the transceiver 608 may include a transmit circuit 612 coupled to a transmit security access block 616 (e.g., a storage device storing a table of transmit access control restrictions) and a receive circuit 614 coupled to a receive security access block 618 (e.g., a storage device storing a table of receive access control restrictions).

To mitigate or prevent the first device 602 from being accessed/changed by rogue software (e.g., over the bus 606) prior to security being established by a bootloader, the first device 602 may be pre-configured (or pre-loaded) with the security access control blocks 616 and 618 that define addresses (e.g., device addresses and/or register addresses or address ranges) with which the first device 602 is permitted or not permitted to communicate. Such addresses may identify other devices on the bus 606, register addresses, and/or groups of devices/registers on the bus. Consequently, when a command is generated or received at the first device 602, the address in the command is checked to see if the address is identified in the security access control block (either as permitted or not permitted). The command is blocked if it is a not to/from a permitted address or if it is absent from the permitted addresses identified by the security access block.

In some examples, this process of checking the security access control block 616 or 618 and blocking commands may be performed only during a defined period of time (e.g., while the security procedure has not completed). In various implementations, the blocking of commands using the security access control block may be performed at the transmitter circuit 612, the receiver circuit 614, and/or a processing circuit which generates a command to be transmitted or which was received over the bus 606. The checking of the security access control block addresses may be disabled or bypassed, for instance, a bootloader security procedure is completed.

In one example, the bus interface circuit 116 in FIG. 1 may implement the security access control blocks 616 and/or 618. In another example, the transceivers 210 and/or 240 in FIG. 2 may implement the security access control blocks 616 and/or 618. In another example, the RFFE interface(s) 308, 314, and/or 316 in FIG. 3 may implement the security access control blocks 616 and/or 618. In yet another example, the SPMI master 418 and/or SPMI slave 420 in FIG. 4 may implement the security access control blocks 616 and/or 618.

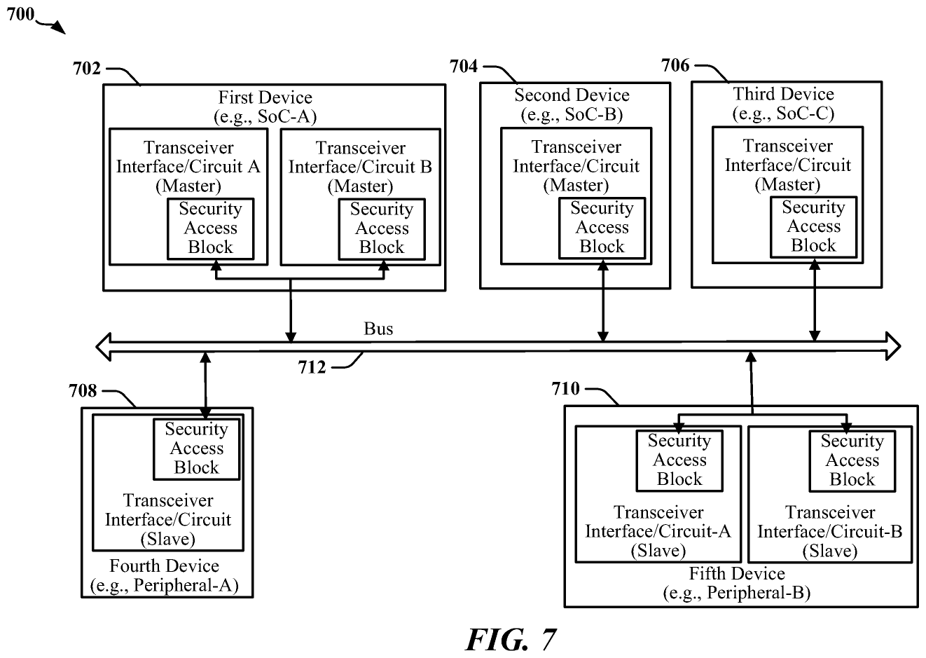

FIG. 7 illustrates a system with various examples of devices having integrated security access blocks that restrict communications to/from the devices prior to other bootloader security procedures being implemented. The system 700 may include a plurality of devices 702, 704, 706, 708, and 710 coupled to a common or shared bus 712. In some implementations, some of the devices 702, 704, and/or 706 to control communications over the bus 712, while other devices 708 and 710 may operate as slave devices relative to communicating over the bus 712. In some examples, a device 702 or 710 may have multiple transceivers coupled to the bus 712. In each of these examples, the devices 702, 704, 706, 708, and 710 may include transceiver interfaces/circuits with integrated security access blocks. As described in FIG. 6, the pre-configured (or pre-loaded) security access blocks may define addresses (e.g., device addresses and/or register addresses or address ranges) with which each device 702, 704, 706, 708, and 710 is permitted or not permitted to communicate. Such addresses may identify other devices on the bus 712, register addresses, and/or groups of devices/registers on the bus. Consequently, when a command is generated or received at one of the devices 702, 704, 706, 708, and 710, the address in the command is checked to see if the address is identified in the security access control block (either as permitted or not permitted). The command is blocked (e.g., according to each corresponding security access block) if the command is a not to/from a permitted address or if it is absent from the permitted addresses identified by the security access block.

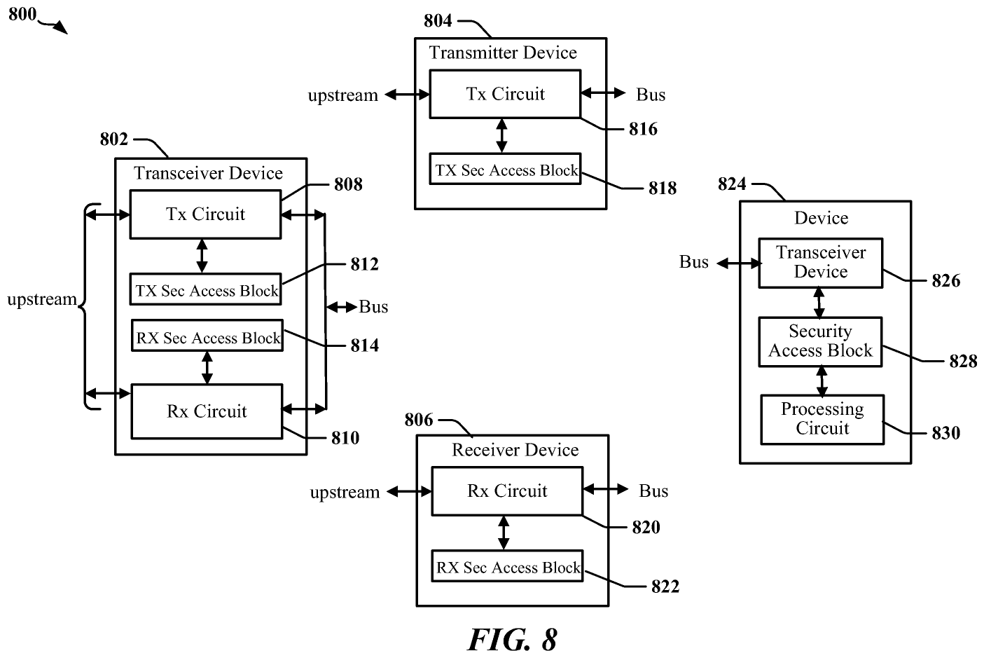

FIG. 8 illustrates various examples of how a security access block may be implanted. In a first example, a transceiver device 802 may include a transmitter circuit 808 coupled to a transmit security access block 812 (e.g., storage device with defined addresses or identifiers a host device, to which the transceiver device 802 is coupled, is allowed or not allowed to access), and a receiver device 810 coupled to a receive security access block 814 (e.g., storage device with defined addresses or identifiers allowed or not allowed to access a host device to which the transceiver device 802 is coupled).

In a second example, only a transmitter device 804, having a transmitter circuit 816, may include a transmit security access block 818; a corresponding receiver device (not shown) may not include a receiver security access block.

In a third example, only a receiver device 806, having a receiver circuit 820, may include a receive security access block 822; a corresponding transmitter device (not shown) may not include a transmitter security access block.

In a fourth example, a device 824 may include a transceiver device 826 and a processing circuit 830 (which may process commands to/from the bus), but the security access block may reside between the transceiver device 826 and the processing circuit 830.

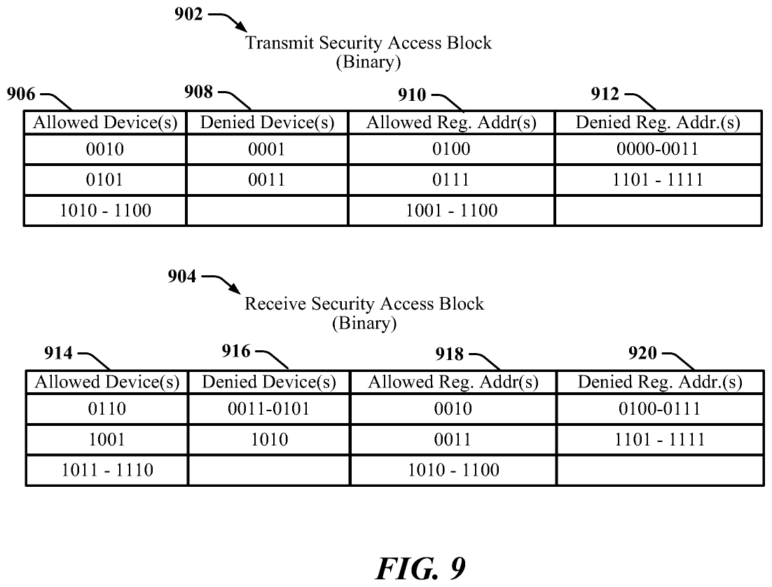

FIG. 9 illustrates examples of security access control blocks. A transmit security access block 902 may include, for instance, a list of allowed device identifiers 908 (or device identifier ranges) to which commands can be transmitted, a list of denied/blocked device identifier 910 to which commands cannot (or should not) be transmitted, a list of allowed register addresses 910 (or register address ranges) to which commands can be transmitted, and/or a list of denied/blocked register addresses 912 (or register address ranges) to which commands cannot (or should not) be transmitted. A device with such transmit security access block 902 may permit or allow the transmission of commands (over the bus) that are intended for (or identify) at least one of the allowed device identifiers 906 or allowed register addresses 910. Likewise, a device with such transmit security access block 902 may block or prevent (e.g., discard) the transmission of commands over the bus which are intended for (or identify) at least one of the denied/blocked device identifiers 908 or denied/blocked register addresses 912.

Similarly, a receive security access block 904 may include, for instance, a list of allowed device identifiers 914 (or device identifier ranges) from which commands can be received, a list of denied/blocked device identifier 916 from which commands cannot (or should not) be received or processed, a list of allowed register addresses 918 (or register address ranges) from which commands can be received, and/or a list of denied/blocked register addresses 920 (or register address ranges) from which commands cannot (or should not) be received. A device with such receive security access block 904 may permit or allow the reception or processing of commands (from the bus) that are intended for (or identify) at least one of the allowed device identifiers 914 or allowed register addresses 918. Likewise, a device with such receive security access block 902 may block or prevent the reception of commands over the bus which are intended for (or identify) at least one of the denied/blocked device identifiers 916 or denied/blocked register addresses 920.

Examples of Devices and Methods Having Integrated Access Control Blocks

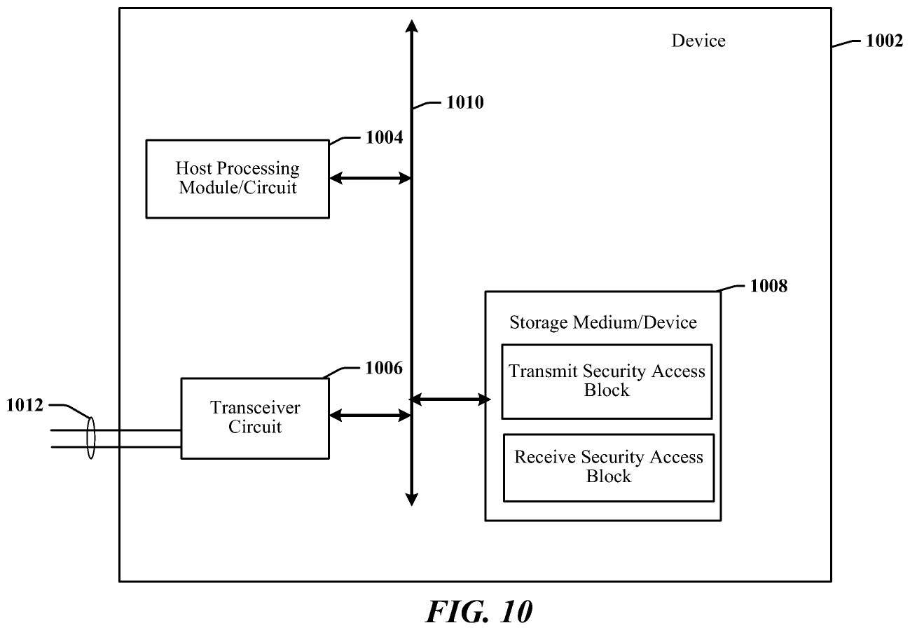

FIG. 10 is a diagram illustrating an example of a device having integrated access control blocks that operate prior to a bootloader security procedures for the device being initiated. The device 1002 may include a host processing circuit/module 1004, a transceiver circuit 1006, and a storage medium/device 1008 (e.g., a processor-readable storage medium), all coupled to a bus 1010. In some implementations, the storage medium/device 1008 may be part of the transceiver circuit 1006 and is not coupled to the bus 1010. The processing circuit 1004 may include one or more processors that are controlled by some combination of hardware and software. Examples of processing circuit 1004 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure.

In the illustrated example, the processing circuit 1004 may be implemented with a bus architecture, represented generally by the bus 1010. The bus 1010 may include any number of interconnecting buses and bridges depending on the specific application of the processing circuit 1004 and the overall design constraints. The bus 1010 links together various circuits including the processing circuit 1004, the transceiver circuit 1006, and the storage device 1008. The transceiver circuit 1006 may serve to couple to a shared or common bus 1012.

The storage device 1008 (e.g., non-volatile storage, etc.) may include memory devices and mass storage devices, and may be referred to herein as computer-readable media and/or processor-readable media. The storage device 1008 may be used for storing a transmit security access control block and/or a receive security access control block, which serve to restrict access to/from the device 1002 prior to any security procedure being implemented as part of a bootloader.

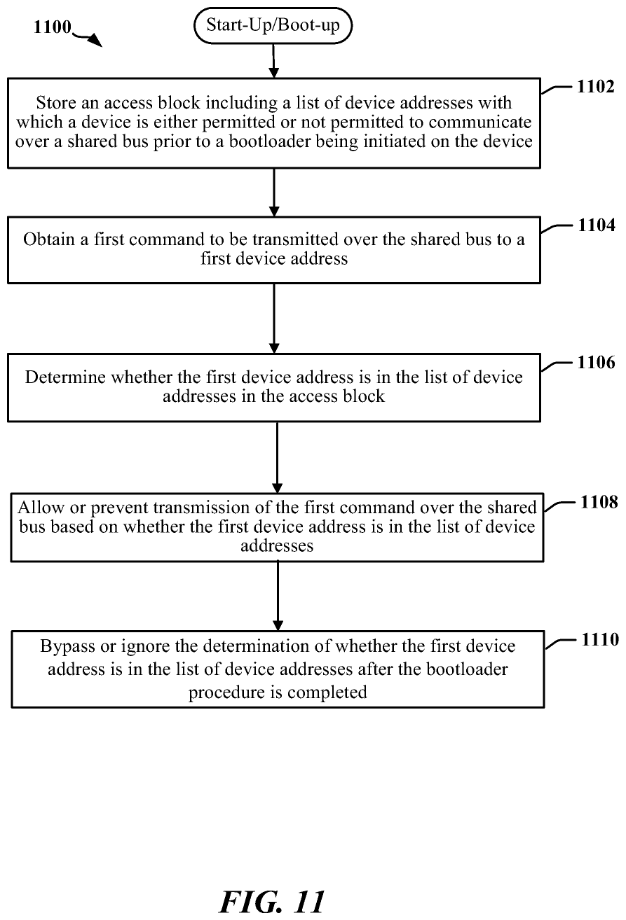

FIG. 11 is a flowchart 1100 of a method that may be performed by a device, having integrated access control blocks, upon boot-up but prior to a bootloader security procedure for the device being initiated. In various examples, this method may be implemented by instructions/code stored in a processor-readable storage medium.

At block 1102, a list of device addresses stored (or pre-stored), the list indicates device addresses which a device is either permitted or not permitted to communicate over a shared bus prior to a bootloader procedure being initiated on the device. In one example, the bootloader procedure may be a security procedure executed after a basic input/output system (BIOS) is loaded for the device. In some implementations, each device address in the list of device addresses may define: (a) one or more devices, (b) one or more register addresses, and/or (c) one or more ranges of addresses. In various examples, the list of device addresses may be stored or pre-loaded during manufacturing of the device or during an initial setup (e.g., by a vendor, manufacturer, or distributor).

At block 1104, a first command to be transmitted over the shared bus to a first device address is obtained (e.g., received from a host processing circuit). For instance, the first command may be one of a read or write command from/to a register in another device associated with the first device address.

At block 1106, a determination is made as to whether the first device address is in the list of device addresses in the access block.

At block 1108, transmission of the first command over the shared bus is allowed or prevented based on whether the first device address is in the list of device addresses. In one example, allowing or preventing transmission of the first command includes: transmiting the first command if: (a) the first device address is in the list of device addresses with which the device is permitted to communicate; or (b) the first device address is not in the list of device addresses with which the device is not permitted to communicate. Additionally, allowing or preventing transmission of the first command may also include: terminating transmission of the first command if: (c) the first device address is in the list of device addresses with which the device is not permitted to communicate; or (d) the first device address is not in the list of device addresses with which the device is permitted to communicate.

At block 1110, the determination of whether the first device address is in the list of device addresses is bypassed or ignored after the bootloader procedure is completed.

According to another example the method may further include receiving a second command over the shared bus from another device having a second device address. A determination is then made as to whether the second device address is in the list of device addresses in the access block. Processing of the second command may be terminated if: (a) the second device address is in the list of device addresses with which the device is not permitted to communicate; or (b) the second address is not in the list of device addresses with which the device is permitted to communicate. Alternatively, the second command may be processed if: (a) the second device address is in the list of device addresses with which the device is permitted to communicate; or (b) the second device address is not in the list of device addresses with which the device is not permitted to communicate.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A device comprising:
a storage device storing an access block that includes a list of device addresses with which the device is either permitted or not permitted to communicate over a shared bus prior to a bootloader procedure being initiated on the device;
a communication circuit coupled to the storage device, the communication circuit is adapted to:
obtain a first command to be transmitted over the shared bus to a first device address;
determine whether the first device address is in the list of device addresses in the access block; and
allow or prevent transmission of the first command over the shared bus based on whether the first device address is in the list of device addresses.

2. The device of claim 1, wherein the communication circuit is further adapted to:
bypass or ignore the determination of whether the first device address is in the list of device addresses after the bootloader procedure is completed.

3. The device of claim 1, wherein the bootloader procedure is a security procedure executed after a basic input/output system (BIOS) is loaded for the device.

4. The device of claim 1, wherein allow or prevent transmission of the first command includes:
transmit the first command if:
(a) the first device address is in the list of device addresses with which the device is permitted to communicate; or
(b) the first device address is not in the list of device addresses with which the device is not permitted to communicate; and
terminate transmission of the first command if:
(c) the first device address is in the list of device addresses with which the device is not permitted to communicate; or
(d) the first device address is not in the list of device addresses with which the device is permitted to communicate.

5. The device of claim 1, wherein the first command is one of a read or write command from/to a register in another device associated with the first device address.

6. The device of claim 1, wherein each device address in the list of device addresses defines:
(a) one or more devices,
(b) one or more register addresses, and/or
(c) one or more ranges of addresses.

7. The device of claim 1, wherein the communication circuit is further adapted to:
receive a second command over the shared bus from another device having a second device address;
determine whether the second device address is in the list of device addresses in the access block; and
terminate processing of the second command if:
(a) the second device address is in the list of device addresses with which the device is not permitted to communicate; or
(b) the second address is not in the list of device addresses with which the device is permitted to communicate.

8. The device of claim 7, wherein the communication circuit is further adapted to:
transmit the second command if:
(a) the second device address is in the list of device addresses with which the device is permitted to communicate; or
(b) the second device address is not in the list of device addresses with which the device is not permitted to communicate.

9. The device of claim 7, wherein the second command is one of a read or write command from/to a register in the device associated with the second device address.

10. The device of claim 1, wherein the communication circuit is a System Power Management Interface (SPMI).

11. A method, comprising:
storing an access block including a list of device addresses with which a device is either permitted or not permitted to communicate over a shared bus prior to a bootloader procedure being initiated on the device;
obtaining, at a communication circuit, a first command to be transmitted over the shared bus to a first device address;
determining whether the first device address is in the list of device addresses in the access block; and
allowing or preventing transmission of the first command over the shared bus based on whether the first device address is in the list of device addresses.

12. The method of claim 11, further comprising:
bypassing or ignoring the determination of whether the first device address is in the list of device addresses after the bootloader procedure is completed.

13. The method of claim 11, wherein the bootloader procedure is a security procedure executed after a basic input/output system (BIOS) is loaded for the device.

14. The method of claim 11, wherein allowing or preventing transmission of the first command includes:
transmiting the first command if:
(a) the first device address is in the list of device addresses with which the device is permitted to communicate; or
(b) the first device address is not in the list of device addresses with which the device is not permitted to communicate; and
terminating transmission of the first command if:
(c) the first device address is in the list of device addresses with which the device is not permitted to communicate; or
(d) the first device address is not in the list of device addresses with which the device is permitted to communicate.

15. The method of claim 11, wherein the first command is one of a read or write command from/to a register in another device associated with the first device address.

16. The method of claim 11, wherein each device address in the list of device addresses defines:
(a) one or more devices,
(b) one or more register addresses, and/or
(c) one or more ranges of addresses.

17. The method of claim 11, further comprising:
receiving a second command over the shared bus from another device having a second device address;
determining whether the second device address is in the list of device addresses in the access block; and
terminating processing of the second command if:
(a) the second device address is in the list of device addresses with which the device is not permitted to communicate; or
(b) the second address is not in the list of device addresses with which the device is permitted to communicate.

18. The method of claim 17, further comprising:
processing the second command if:
(a) the second device address is in the list of device addresses with which the device is permitted to communicate; or
(b) the second device address is not in the list of device addresses with which the device is not permitted to communicate.

19. The method of claim 11, wherein the communication circuit is a System Power Management Interface (SPMI).

20. A processor-readable storage medium comprising code for:
storing an access block including a list of device addresses with which a device is either permitted or not permitted to communicate over a shared bus prior to a bootloader procedure being initiated on the device;
obtaining a first command to be transmitted over the shared bus to a first device address;
determining whether the first device address is in the list of device addresses in the access block; and
allowing or preventing transmission of the first command over the shared bus based on whether the first device address is in the list of device addresses.

21. The processor-readable storage medium of claim 20, further comprising code for:
bypassing or ignoring the determination of whether the first device address is in the list of device addresses after the bootloader procedure is completed.

22. A device comprising:
means for storing an access block including a list of device addresses with which a device is either permitted or not permitted to communicate over a shared bus prior to a bootloader procedure being initiated on the device;
means for obtaining a first command to be transmitted over the shared bus to a first device address;
means for determining whether the first device address is in the list of device addresses in the access block; and
means for allowing or preventing transmission of the first command over the shared bus based on whether the first device address is in the list of device addresses.

23. The device of claim 22, further comprising:
means for bypassing or ignoring the determination of whether the first device address is in the list of device addresses after the bootloader procedure is completed.
